(19) United States
(12) Patent Application Publication
(10) Pub. No.: US 2011/0037733 A1
(43) Pub. Date: Feb. 17, 2011

(54) IMAGE DISPLAY APPARATUS FOR DETECTING POSITION

(75) Inventor: Jae Seong YI, Seoul (KR)

Correspondence Address: AMPACC Law Group, PLLC, 6100 219th Street SW, Suite 580, Mountlake Terrace, WA, 98043, US

(73) Assignee: NURIBOM, Seoul (KR)

(21) Appl. No.: 12/853,928

(22) Filed: Aug. 10, 2010

(30) Foreign Application Priority Data
Aug. 11, 2009 (KR) 10-2009-0073780

(51) Int. Cl. G06F 3/042

(52) U.S. Cl. 345/175

(57) ABSTRACT

Provided is an image display apparatus capable of detecting a position. The image display apparatus includes an indicator detector disposed in the vicinity of a detection surface displaying an image and sensing an operation of an indicator on the detection surface and including an image sensor capable of controlling an angle between the detection surface and a main sensing direction. A reflection frame is disposed in the vicinity of the detection surface.

### CROSS-REFERENCE TO RELATED APPLICATIONS

This application claims priority under 35 U.S.C. §119 to Korean Patent Application No. 10-2009-0073780, filed on Aug. 11, 2009, in the Korean Intellectual Property Office, the disclosure of which is incorporated herein by reference in its entirety.

### TECHNICAL FIELD

The present invention relates to an image display apparatus, and more particularly, to an image display apparatus for detecting a position by using an image sensor.

### BACKGROUND

An image display apparatus is connected with an apparatus having image information to display the image information on a screen. The image display apparatus is being used in various kinds of electronic appliances while having various sizes, for example, it is being applied to a portable terminal such as a mobile communication phone, a personal computer, a notebook, and a television.

The image display apparatus was limited to a function of just displaying the image information in the past, but in recent years, it allows a user to personally input necessary information on a screen for user's convenience. A touch-type image display apparatus may receive data by using an indicator such as a user's finger or a user's private pen.

The touch-type image display apparatus generally includes a detection member detecting the indicator positioned on the screen and is classified into various types including an electromagnetic induction type, a capacitance type, a decompression type, and an optical type in accordance with an implementation type of the detection member.

First, the electromagnetic induction type acquires a 2D coordinate from the plane distribution of the radiation intensity of electromagnetic waves radiated from the indicator itself to detect the indicator. In this type, it is inconvenient in that the data cannot be inputted by means of a finger, and the user's private pen radiating the electromagnetic waves is needed.

Next, the capacitance type includes a thin film having capacitance on the screen, and in case the indicator such as the finger contacts the screen, the coordinate of the indicator is detected by measuring a variation of the capacitance.

The decompression type includes a resistance thin film in the screen to detect the indicator in a method similar to the capacitance type. The capacitance type and the decompression type have a problem in that the screen becomes damaged at the time of using a sharp indicator. Further, these types may be used in a small-size screen, but they are not suitable for a method of displaying an image on a large-size screen by using a projection device such as a projector, not just a panel type.

The optical type includes a reflector in the vicinity of the screen and uses light which is inputted at the edge of the screen and thereafter, reflected on and returned from the reflector. The optical type measures the angle of the indicator from a shadow blocked by the indicator such as the finger, and compute a coordinate in accordance with a triangulation principle on the basis of the measured angle.

Meanwhile, the small-size electronic appliance such as the portable terminal primarily adopts the capacitance type, but as described above, in the case in which a touch screen technique is applied to an image projected on the large-size screen by using the projector, the optical type is more advantageous than other types in respects to implementability and cost.

FIG. 1 is an optical type image display apparatus having a touch screen function in the prior art and FIG. 2 is top view of an optical type image display apparatus in the prior art.

In the optical type image display apparatus, an image is projected on a screen 10, a virtual detection surface 12 is provided as an area detecting the movement of an indicator 22 in the image, and indicator detectors 14 are disposed at both ends on one side in the vicinity of the detection surface 12.

Each of the indicator detectors 14 includes an image sensor and at least one light source therein. Reflectors 16 are consecutively positioned on three sides in the vicinity of the detection surface 12 other than one side connecting the indicator detectors 14.

In the optical type image display apparatus, reflected light having discontinuity, which is emitted from the reflector 16 is photographed by image sensors of the indicator detectors 14 to generate sensing information, and coordinate information of the indicator 22 is generated by using the sensing information.

In the image display apparatus in the prior art, light 20 having a first incident distance farther from the indicator detector 14 has lower illumination than light 18 having a second incident distance closer from the indicator detector 14 in respects to the reflected light of the reflector 16. Further, in the case in which the light 20 having the first incident distance is inputted into the reflector 16 at more than 60 degrees, the reflected light is not recursively reflected to the indicator detector 14 and as a result, the reflected light cannot be detected by the indicator detector 14. Consequently, the light reflected from the reflector 16 having the first incident distance is sensed with low illumination, thus, an error may occur in sensing the indicator 22.

Meanwhile, the image sensor is generally constituted by a linear image sensor. The linear image sensor does not require vertical-direction information while sensing the indicator and is designed to detect the position of a shadow or light in a horizontal direction.

As shown in FIG. 2, in the case in which the surface of the screen 10 is not uniform, the indicator detectors 14 having the linear image sensors are arranged not to be parallel between a main sensing direction (a) and a horizontal line (b) parallel to a detection surface.

Even though the indicator detectors 14 are accurately aligned during installation, the positions of the indicator detectors 14 may be changed while returning or using a product. Therefore, a possibility of misalignment may still be high.

A photographed image of the reflected light is distorted due to the misalignment of the linear image sensor, such that the sensing accuracy of the indicator 22 is deteriorated. In order to modify the deteriorated sensing accuracy.

To solve this problem, software processing may be considered, but the software processing causes a data processing speed to be delayed in the image display apparatus of the indicator.

### SUMMARY

An exemplary embodiment of the present invention provides an image display apparatus that includes an indicator detector disposed in the vicinity of a detection surface displaying an image and sensing an operation of an indicator on the detection surface and including an image sensor capable of controlling an angle between the detection surface and a main sensing direction. A reflection frame is disposed in the vicinity of the detection surface.

In some exemplary embodiments of the present invention, the image sensor may include a body tube positioned to face the reflection frame and a case disposed in the rear of the body tube and housing a sensor module.

The indicator detector may include a mounting portion having space receiving the lower part of the image sensor, and a body tube supporter coupled with the mounting portion and partially supporting the lower part of the body tube.

A projection covering the top of the case in the vicinity of the barrel may be provided. A control member penetrating the projection and controlling the angle between the detection surface and the main sensing direction by vertically adjusting the case on the basis of the lower part of the body tube may be provided. In addition, the indicator detector may include a body tube guide in the front of the body tube supporter.

Another exemplary embodiment provides an image display apparatus that includes one or more indicator detectors disposed on the end of one side in the vicinity of a detection surface displaying an image and sensing an operation of an indicator on the detection surface.

Reflection frames are disposed on sides other than the one side in the vicinity of the detection surface and the reflection frame facing the one side includes one or more protruded auxiliary reflectors.

In some exemplary embodiments of the present invention, the auxiliary reflector may include one or more inclined surfaces or rounded surfaces.

In another exemplary embodiments, the plurality of auxiliary reflectors may be disposed and when each of the auxiliary reflectors includes one inclined surface, inclined surfaces of the auxiliary reflectors may be symmetrical to each other while facing each other on the basis of the centers of the reflection frames facing each other, and the auxiliary reflectors may be disposed adjacent to each other at both ends of the reflection frame facing each other.

In yet another exemplary embodiment, when the plurality of auxiliary reflectors are disposed, each of the auxiliary reflectors includes two inclined surfaces and an angle between the both inclined surfaces may be in the range of 40 to 180 degrees.

In yet another exemplary embodiment, the auxiliary reflector may have a size smaller than the indicator.

In yet another exemplary embodiment, the reflection frame may include a lower reflection frame facing the one side, and a left reflection frame and a right reflection frame positioned at the left side and the right side of the lower reflection frame. The left and right reflection frames adjacent to the lower reflection frame may include the auxiliary reflector.

Yet another exemplary embodiment provides an image display apparatus that includes an indicator detector disposed in the vicinity of a detection surface. The indicator detector senses an operation of an indicator on the detection surface and includes an image sensor, and first and second light emitting elements having different illuminations positioned in the vicinity of the image sensor. A reflection frame is positioned in the vicinity of the detection surface.

In some exemplary embodiments of the present invention, when the first light emitting element has a larger incident distance than the second light emitting element, the first light emitting element may have higher illumination than the second light emitting element.

Still another exemplary embodiment provides an image display apparatus that includes an indicator detector disposed in the vicinity of a detection surface displaying an image and sensing operations of first and second indicators on the detection surface. A control unit calculating coordinates of the indicators on the detection surface on the basis of sensing information transmitted from the indicator detector and generating operation information relating to sequential sensing or simultaneous sensing of the first and second indicators is provided. An image processing unit generating an image conversion signal on the basis of the coordinates and the operation information transmitted from the control unit is provided. A projection device projecting a converted image based on the image conversion signal transmitted from the image processing unit is provided.

Other features and aspects will be apparent from the following detailed description, the drawings, and the claims.

### BRIEF DESCRIPTION OF THE DRAWINGS

FIG. 1 is a n optical type image display apparatus having a touch screen function in the prior art;

FIG. 2 is a top view of an optical type image display apparatus in the prior art;

FIG. 3 is an image display apparatus according to an exemplary embodiment of the present invention;

FIG. 4 is a perspective view of an indicator detector;

FIG. 5 is a perspective view showing an inner part of an indicator detector;

FIG. 6 is an image display apparatus according to another exemplary embodiment of the present invention;

FIG. 7 is a top view of an indictor detector showing an operation of the indicator detector in an image display apparatus according to an exemplary embodiment of the present invention;

FIG. 8 is a graph illustrating the reflectance of a reflection frame used in an image display apparatus in the prior art;

FIG. 9 is a graph illustrating the reflectance of an auxiliary reflector used in an image display apparatus according to another exemplary embodiment of the present invention;

FIG. 10 is a graph illustrating an amount of reflected light sensed on an edge portion of a reflection frame used in an image display apparatus in the prior art;

FIG. 11 is a graph illustrating an amount of reflected light sensed on an edge portion of a reflection frame used in an image display apparatus according to another exemplary embodiment of the present invention;

FIG. 12 is a flowchart illustrating an operation relating to a change of a configuration of an image depending on an operation pattern of a second indicator while a first indicator is sensed in an image display apparatus according to yet another exemplary embodiment of the present invention;

FIG. 13 is a schematic diagram of an image displayed in the image;

FIG. 14 is a schematic diagram of an image displaying zoom-out windows arranged in the image; and

FIG. 15 is a flowchart illustrating an operation relating to a change of a configuration of an image depending on an operation pattern of one indicator after both first and second indicators are sensed in an image display apparatus according to yet another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the drawings, the thickness of layers, films, panels, regions, etc., are exaggerated for clarity. Like elements refer to like reference numerals throughout the specification. It will be understood that when an element such as a layer, film, region, or substrate is referred to as being “on” another element, it can be directly on the other element or intervening elements may also be present.

Further, when an element is referred to as being “below” another element, it can be directly below the other element or intervening elements may also be present. The top, bottom, left and right described throughout the specification may conversely be analyzed depending on a viewpoint viewing the drawings.

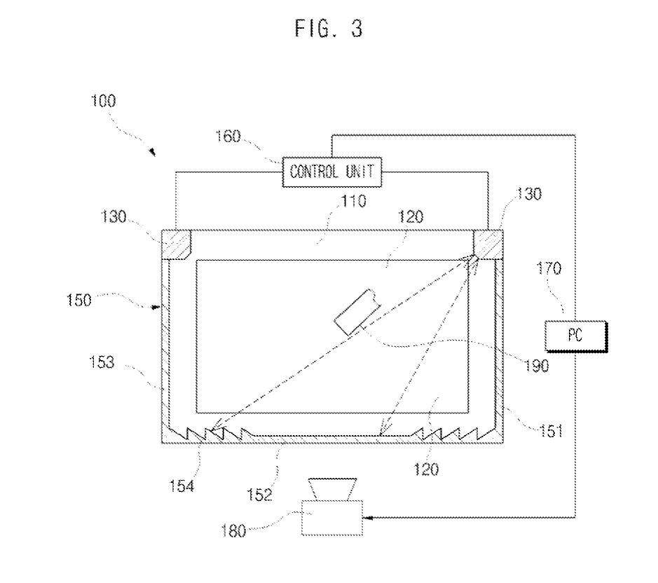

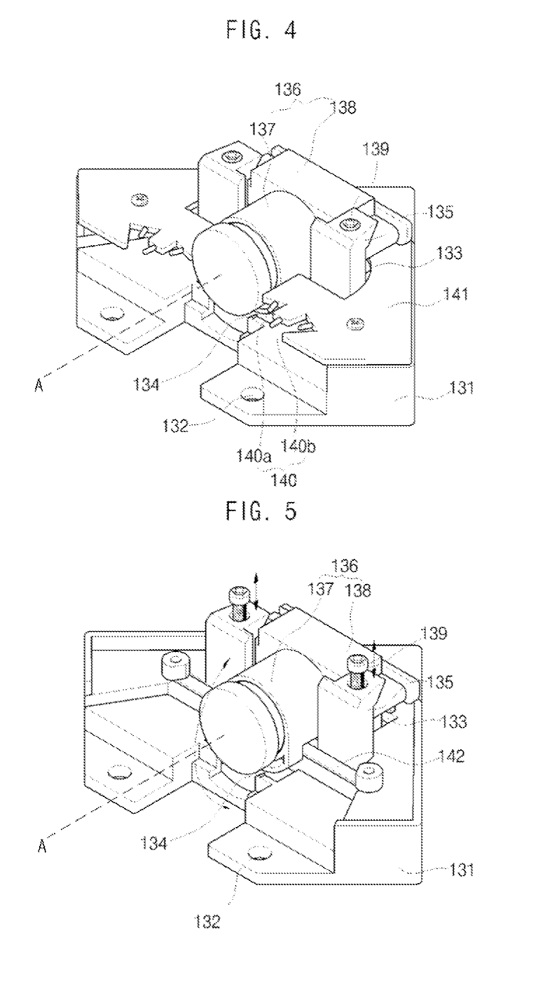

Hereinafter, referring to FIGS. 3 to 5, an image display apparatus according to an exemplary embodiment of the present invention will be described in detail. FIG. 3 is an image display apparatus according to an exemplary embodiment of the present invention, FIG. 4 is a perspective view of an indicator detector, and FIG. 5 is a perspective view showing an inner part of an indicator detector.

Referring to FIG. 3, the image display apparatus 100 as an optical type image display apparatus capable of detecting the position of an indicator 190 includes a virtual detection surface 120 which is a part where an image provided through a projection device 180 such as a projector is projected on a screen 110.

The detection surface 120 corresponds to a region sensing the movement of the indicator 190. In this case, a finger as a part of a human body or an exclusive pen may be used as the indicator 190 and the screen 110 may be made of a substantially rigid material, for example, may be a board panel or a blackboard generally installed in a lecture room or a business conference room.

Indicator detectors 130 are disposed at both ends of one side in the vicinity of the detection surface 120 on the screen 110 to sense the movement of the indicator 190. In this case, the indicator detectors 130 may be implemented to sense operations of two or more indicators 190.

As shown in FIGS. 4 and 5, the indicator detectors 130 may be installed to be screw-engaged to edges in the vicinity of the detection surfaces 120 through connectors 132. Each of the indicator detectors 130 includes an image sensor 136. The image sensor 136 may include a body tube 137 positioned toward a reflection frame 150 to be described later and a case 138 disposed in the rear of the body tube 137.

One or more small-size lenses (not shown) may be mounted on the body tube 137 and the case 138 may house a sensor module (not shown). As the sensor module used in the image sensor 136, various types such as a CCD type, a CMOS type, and the like may be used. The sensor module in the exemplary embodiment may adopt a CMOS type linear image sensor capable of operating at high speed without an additional A/D converter, or the like.

The image sensor 136 may be mounted on a mounting portion 131 providing space for receiving the lower part thereof. To be specific, the case 138 may be inserted into and mounted on a case receiver 133 of the mounting portion 131 and the case receiver 133 may be provided as space larger than the case 138 in order to vertically move the case 138.

Further, as shown in FIG. 5, the lower part of the body tube 137 may be partially supported by a body tube supporter 142 coupled with the mounting portion 131. In this case, the body tube supporter 142 may be formed by a member having elasticity such as a plate spring. Meanwhile, a projection 135 may be positioned on the top of the case 138 so that the case 138 is fixed to the mounting portion 131.

In this case, the case 138 is positioned between the case receiver 133 and the projection 135, but space therebetween may be larger than the size of the case 138 so that the case 138 minutely moves therein. A control member 139 that penetrates the projection 135 is disposed on one surface of the projection 135 facing the top of the case 138 and may be constituted by, for example, screws so as to vertically control the case 138.

Therefore, as shown in FIG. 5, the body tube supporter 142 serves as a center point of a lever to control the screws which are the control member 139, such that the body tube 137 and the case 138 may be integratively moved in link with each other.

For example, when the body tube 137 with the lens moves upwards, the case 138 including the sensor module therein moves downwards. Therefore, they may move in opposite directions to each other. As a result, it is possible to adjust an angle between a main sensing direction A of the image sensor 136 and the detection surface 120. Herein, the main sensing direction A represents the direction of a virtual line penetrating a primary photographing region of the sensor module from the center of the lens in the barrel 137. To be specific, the center of the lens is a portion where a primary image of reflected light emitted from the reflection frame 150 is formed. In addition, the body tube 137 and the case 138 are integratively linked with each other to shift the main sensing direction A and as a result, a relative position between the lens and the sensor module is not changed. That is, when the main sensing direction A shifts, a control operation of the case including the sensor module is not additionally required.

Besides, a body tube guide 134 may be positioned in front of the body tube supporter 142 so that the body tube 137 moves downwards only in a vertical direction.

In the exemplary embodiment, the control member such as the screws is used as an example, but the present invention may be modified in various forms without departing from the scope for adjusting the angle between the main sensing direction A and the detection surface 120.

Meanwhile, as shown in FIG. 4, a cover 141 having portions into which the image sensor 136 and the projection 135 are inserted may be positioned on the mounting portion 131. The cover 141 includes a portion capable of receiving a light source so as to dispose light sources 140 in the vicinity of the body tube 137 and the light source 140 may include one or more light emitting elements 140a and 140b.

For example, the first and second light emitting elements 140a and 140b may be disposed to face different directions depending on the structure of the reflection frame 150 and may have different illuminations by considering a distance from the reflection frame 150 and an incident angle radiated to the reflection frame 150.

Moreover, the first and second light emitting elements 140a and 140b may be constituted by infrared-ray (IR) emitting elements. If the first light emitting element 140a has a larger incident distance than the second light emitting element 140b, the first light emitting element 140a may have higher illumination than the second light emitting element 140b. As a result, even light that is reflected on the reflection frame 150 which is far away from the indicator detectors 140 may have substantially the same illumination as reflected light of the reflection frame 150 which is close to the indicator detectors 130. Accordingly, the sensing accuracy of the indicator may be improved by using sensing information on the basis of the reflected light even on the detection surface 120 having a large area.

Meanwhile, as shown in FIG. 3, the reflection frames 150 may be consecutively disposed on all sides of the detection surfaces 120 other than one side where the indicator detectors 130 are disposed. The disposition aims at accurately detecting a shadow part corresponding to the indicator 190.

The reflection frame 150 may be formed by a recursive reflector, for example, which reflects light so that reflected light for light emitted from a right indicator detector 130 is again detected by the right indicator detector 130. The recursive reflector may recursively reflect light within a limit of an incident angle of the maximum 60 degrees.

When the detection surface 120 has a quadrangular shape, the reflection frame 150 may include the right reflection frame 151, a left reflection frame 153, and a lower reflection frame 152. The lower reflection frame 152 is a frame facing one side where the indicator detectors 130 are disposed.

The lower reflection frame 152 includes one or more protruded auxiliary reflectors 154. In this case, the auxiliary reflector 154 may have one or more inclined surfaces or rounded surfaces depending on conditions such as a material, an incident angle, an amount of reflected light. In addition, since light radiated from the lower reflection frame 152 which is far away from the indicator detectors 130 has a large incident angle, the auxiliary reflectors 154 may be positioned at portions adjacent to both ends of the lower reflection frame 152.

Meanwhile, when each of the auxiliary reflectors 154 has one inclined surface, the inclined surfaces may be designed to be symmetrical to each other while facing each other on the basis of the center of the lower reflection frame 152. To be specific, the left auxiliary reflectors 154 may have inclined surfaces facing the right indicator detector 130 on the basis of the center of the lower reflection frame 152 and the right auxiliary reflectors 154 may also have inclined surfaces facing the left indicator detector 130. As a result, it is possible to prevent the reflected light from being not sensed by each of the indicator detectors 130.

In this case, the angle of the inclined surface may be controlled by considering the illuminations of the indicator detectors 130 and the amount of the reflected amount recurred from the reflection frame 150.

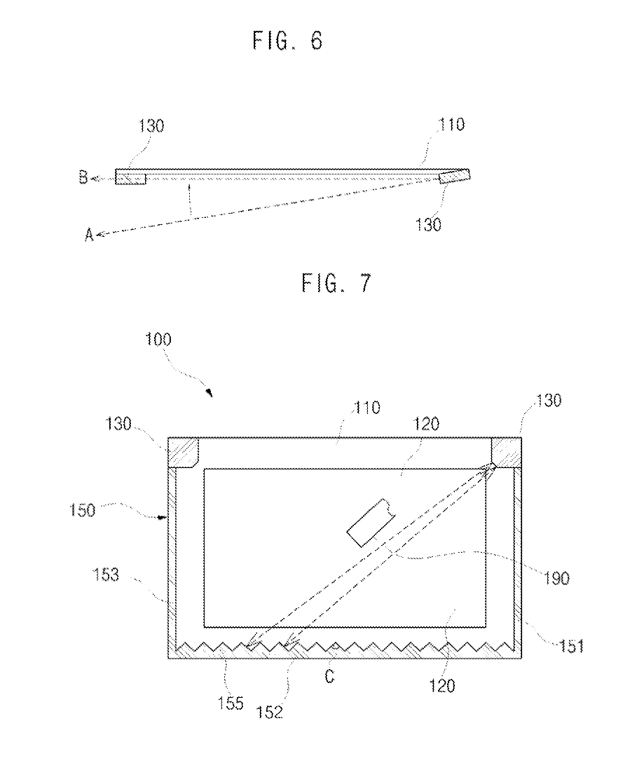

The auxiliary reflector may have a shape different from the above-mentioned shape and the exemplary embodiment thereof will be shown in FIG. 6. FIG. 6 is an image display apparatus according to other exemplary embodiments of the present invention. In other exemplary embodiments, each of auxiliary reflectors 155 may have a saw shape each of two inclined surfaces.

In this case, the auxiliary reflectors 155 may be positioned on the entire part or a part of the lower reflection frame 152 by considering all conditions such as the illuminations and the amounts of reflected light of the indicator detectors 130. Inclined surfaces of the auxiliary reflectors 155 may be configured to be symmetrical to each other. An angle C which is an interior angle between both inclined surfaces may be in the range of 40 to 180 degrees depending on a material of the auxiliary reflector 155. The light amount of reflected light is increased by the auxiliary reflectors 155 having both inclined surfaces to thereby reduce an error in recognizing the indicator 190. Moreover, the size of the auxiliary reflector 155 may be designed to have a smaller size than that of indicator 190. As a result, it is possible to improve the sensing accuracy of the indicator 190.

In yet another exemplary embodiment, although not shown, when a vertical length is larger than a horizontal length on a quadrangular detection surface 120, the auxiliary reflectors may be positioned in even left and right reflection frames 151 and 153 adjacent to the edges of the lower reflection frame 152.

The auxiliary reflectors 154 are provided in the reflection frame 150, such that the reflected light is not leaked to the outside and may be recursively radiated to the indicator detectors 130. Accordingly, the sensing accuracy of the indicator can be improved by using sensing information on the basis of the reflected light even on the detection surface 120 having a large area.

Referring back to FIG. 3, the image display apparatus 100 may include a control unit 160 that calculates a coordinate of the indicator 190 in the detection surface on the basis of sensing information transmitted from the indicator detectors 130 and specific operations of the indicator and generates specific operation information.

In this case, the information on the specific operations is the information relating to sequential sensing or simultaneous sensing of the first and second indicators. The control unit 160 may be installed as a device other than the indicator detectors 130 and may exchange data with the indicator detectors 130 through wire or wireless communication. Details thereof will be described below.

The image display apparatus 100 may further include an image processing unit 170 generating an image conversion signal on the basis of coordinates and operation information transmitted from the control unit 160 and an image device projecting an converted image based on the image conversion signal transmitted from the image processing unit 170.

The image processing unit 170 may perform such a function by using a general computer. The image processing unit 170 may generally use a personal computer, but in this case, the image processing unit 170 may perform data communication with the control unit 160 by a wired line or by wireless.

Hereinafter, referring to FIGS. 5 and 7, an operation of the image display apparatus according to the exemplary embodiment of the present invention will be described. FIG. 7 is a top view of an indictor detector showing an operation of the indicator detector in an image display apparatus according to an exemplary embodiment of the present invention.

When the surface on the screen 110 to which the indicator detectors 130 are engaged is not uniform, the main sensing direction A of the image sensor 136 may not be parallel to a horizontal line B parallel to the detection surface 120. The main sensing direction A of the image sensor 136 is adjusted to be parallel to the horizontal line B by using the control member such as the screws of the indicator detectors 130 in order to modify them to be parallel to each other.

As a result, since image distortion of the image sensor 136 can be prevented, the sensing accuracy of the indicator is improved. Further, since the software processing for compensation of the image distortion may be omitted by using a simple mechanical control, it may be advantageous even in preventing the delay in the data processing speed.

Moreover, the body tube 137 and the case 138 are integratively linked with each other to shift the main sensing direction A and as a result, a relative position between the lens and the sensor module is not changed. That is, when the main sensing direction A shifts, a control operation of the case 138 including the sensor module is not additionally required.

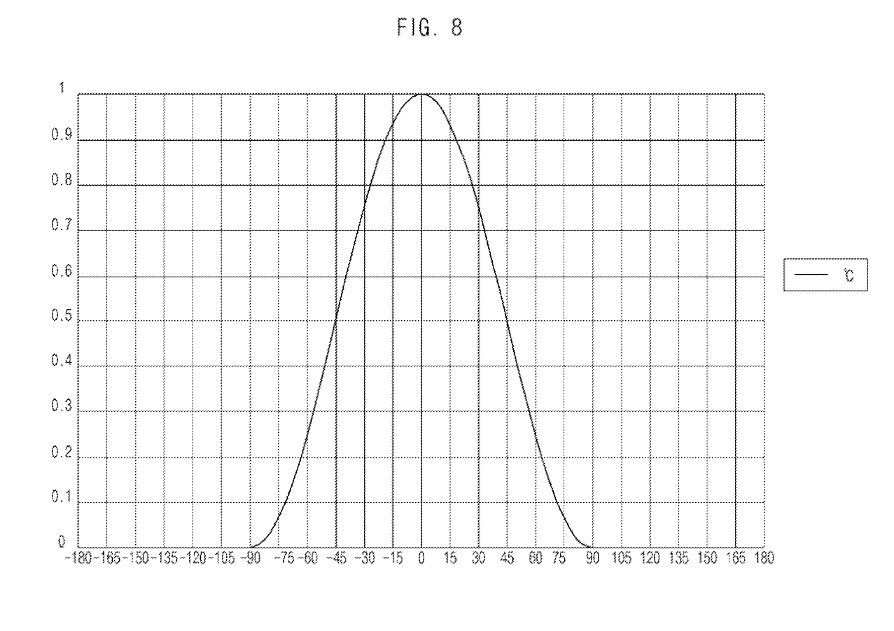

Hereinafter, referring to FIGS. 8 to 11, the present invention will be described in more detail through experimental examples and comparative examples. However, the experimental examples are used to exemplify the present invention and it should be appreciated that the present invention is not limited by the experimental examples.

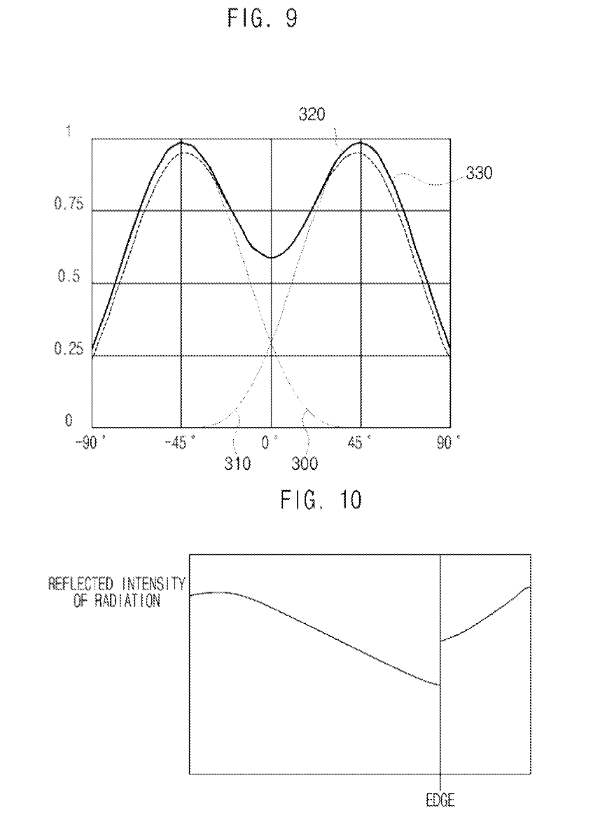

FIGS. 8 and 9 show data relating to the reflectance of a reflection frame used in an image display apparatus in the prior art and the reflectance of an auxiliary reflector used in an image display apparatus according to another exemplary embodiment of the present invention. FIG. 8 is a graph illustrating the reflectance of a reflection frame used in an image display apparatus in the prior art and FIG. 9 is a graph illustrating the reflectance of an auxiliary reflector used in an image display apparatus according to another exemplary embodiments of the present invention.

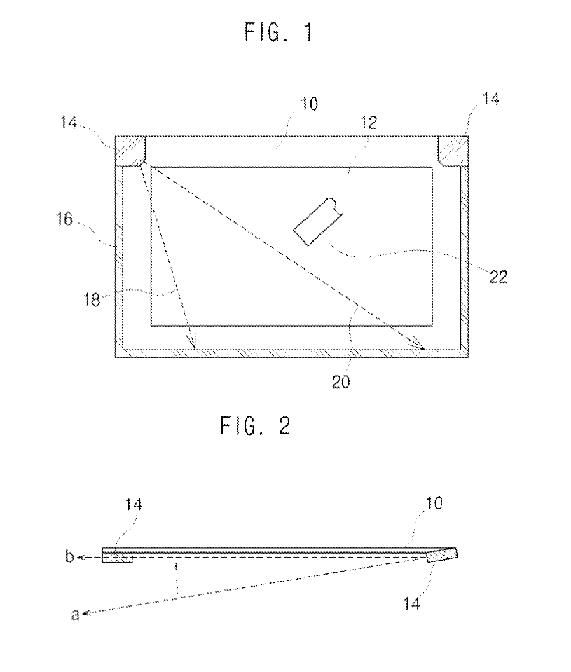

In the comparative example of FIG. 8, the indicator detector (the indicator detector of FIG. 4) is installed on one surface of the reflection frame having a plane shown in FIG. 1 and the indicator detector measures the reflected intensity of radiation reflected from the reflection frame while changing the incident angle of the light radiated from the reflection frame.

Subsequently, the reflectance is calculated by using the intensity of the radiated light and the intensity of the reflected light. To be specific, the reflectance is a ratio of the intensity of the reflected light to the intensity of the radiated light. Meanwhile, in the experimental example of FIG. 9, the reflection frame with the auxiliary reflector having two inclined surfaces of FIG. 6 is used.

To be specific, in the experimental example of FIG. 9, the reflectance is calculated while changing an incident angle of light emitted to one inclined surface between two inclined surfaces. In the experimental example of FIG. 9, the reflection frame with one auxiliary reflector is used and an angle between both inclined surfaces of the auxiliary reflector is designed to be 50 degrees.

In FIG. 8, a horizontal axis represents an incident angle which is an angle at which the light emitted from the indicator detector is inputted onto the reflection frame and a vertical axis represents the reflectance. The incident angle is an angle between a vertical line perpendicular to the plane of the reflection frame and an incident direction of light. As shown in FIG. 8, when the incident angle is 0 degree, the reflectance is substantially close to 1, while when the incident angle is higher than 45 degrees, the reflectance is decreased to 0.5 or lower.

On the basis of the data, in the image display apparatus in the prior art, when the incident angle is high, the amount of the reflected light is rapidly decreased. As a result, a possibility of error occurrence in detecting the indicator is increased.

Referring to FIG. 9, reference numeral “300” represents reflectance depending on a change of an incident angle on one inclined surface between both inclined surfaces. The calculation of the reflection for one inclined surface starts from firstly acquiring reflectance of one inclined surface when the incident angle is 0 degree.

Next, a ratio of a valid reflection area of one inclined surface depending on the change of the incident angle to areas of both inclined surfaces is acquired. Subsequently, the variation rate of one inclined surface depending on the change of the incident angle may be calculated by multiplying the ratio by the reflectance when the incident angle is 0 degree.

As shown in Graph “300” acquired through the calculation, the reflectance is at the maximum when the incident angle is approximately −50 degrees. Unlike this, reference number “310” represents reflectance depending on an incident angle on the other inclined surface. This is because the inclined surfaces are symmetrical to each other. As a result, in reference numeral “310”, the reflectance is at the maximum when the incident angle is approximately 50 degrees.

Reference numeral “320” represents the overall reflectance of the auxiliary reflector by considering both inclined surfaces and is a result acquired by adding reference numerals “300” and “310” to each other. As described in reference numeral “320”, even when the incident angle is +50 degrees or −50 degrees, high reflectance is acquired unlike the comparative example of FIG. 8.

In addition, even when the incident angle reaches approximately 76 degrees, the reflectance is 60% or more. On the basis of the data, unlike the reflection frame having the plane in the prior art, in the reflection frame of the exemplary embodiment, even when the incident angle is large, the reflected intensity of radiation is not decreased. Accordingly, it is possible to reduce an indicator detection error.

Meanwhile, reference numeral “330” represents reflectance considering a reflectance weight depending on a reflectance distance. Reference numeral “330” also has a pattern similar to reference numeral “320”.

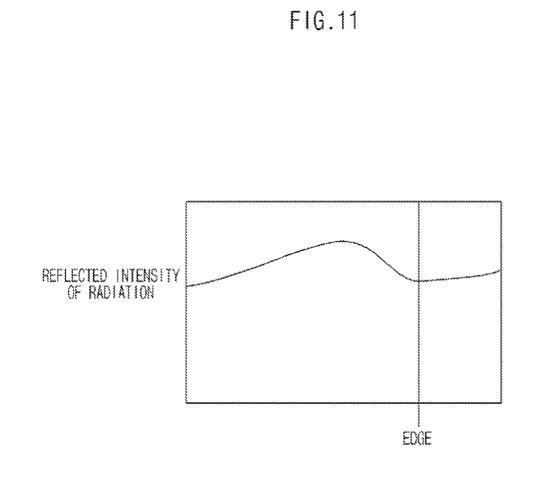

FIGS. 10 and 11 show data relating to the reflected intensity of radiation of a reflection frame in the prior art and the reflected intensity of radiation of an auxiliary reflector according to the present invention. FIG. 10 is a graph illustrating an reflected intensity of radiation sensed on an edge portion used in an image display apparatus in the prior art and FIG. 11 is a graph illustrating reflected intensity of radiation sensed at an edge portion used in an image display apparatus according to another exemplary embodiments of the present invention.

In the comparative example of FIG. 10, light of the indicator detector is radiated to a left edge portion of the reflection frame shown in FIG. 1 and a reflected intensity of radiation reflected at the edge portion is measured. Meanwhile, in the experimental example of FIG. 11, the reflection frame with the auxiliary reflector shown in FIG. 6 is used and a plurality of auxiliary reflectors are installed on the reflection frame. Further, an angle between both inclined surfaces is designed to be 50 degrees.

“Edge” written on the horizontal axis of FIGS. 10 and 11 represents a portion where a left frame and a lower frame meet each other and the left side of the “edge” is a left frame region ad the right side of the “edge” is a lower frame region. A vertical axis of FIGS. 10 and 11 represents reflected intensity of radiation.

As shown in FIG. 10, the reflected intensity of radiation at the edge portion is deteriorated and shows discontinuity. This is based on a fact that any one of an incident angle of the lower frame and an incident angle of the left frame is the larger. To be specific, in FIG. 10, since the incident angle of the left frame is the larger, the reflected intensity of radiation of the left reflection frame is rapidly decreased.

As a result, since the reflected intensity of radiation shows discontinuity at the edge portion, the error occurs in detecting the indicator.

Contrary to this, as shown in FIG. 11, the reflected intensity of radiation at the edge portion is not rapidly decreased and shows continuity. This is based on a fact that as described in reference numeral “320” of FIG. 9, when the incident angle is large, the reflected intensity of radiation is not decreased. That is, auxiliary reflectors at the edge portion can prevent the reflected intensity of radiation from being deteriorated. As a result, the reflected intensity of radiation at the edge portion has a continuous value to thereby improve the accuracy in sensing the indicator.

Hereinafter, referring to FIGS. 3 and 12 to 14, an image display apparatus according to another exemplary embodiment of the present invention will be described.

Another exemplary embodiment, which describes the sequential sensing of first and second indicator, relates to a change in the configuration of an image depending on an operation pattern performed by the second indicator since then while the first indicator is sensed on the detection surface 120.

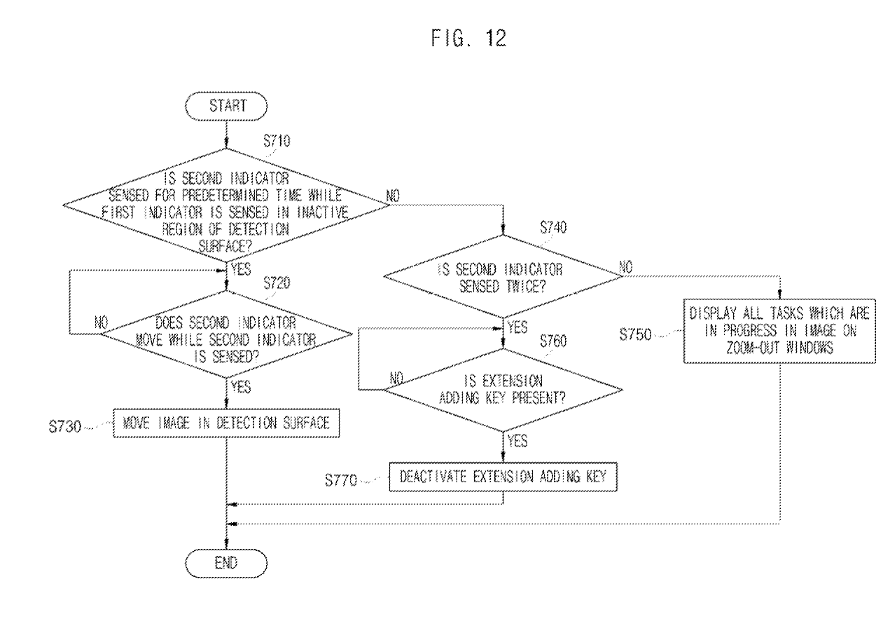

FIG. 12 is a flowchart illustrating an operation relating to a change of a configuration of an image depending on an operation pattern of a second indicator while a first indicator is sensed in an image display apparatus according to yet another exemplary embodiment of the present invention. FIG. 12 is a schematic diagram of an image displayed in the image and FIG. 9 is a schematic diagram of an image displaying zoom-out windows arranged in the image.

Referring to FIGS. 3, 12, and 13, first, the control unit 160 may determine whether a second indicator 190b is continuously sensed on the detection surface 120 for a predetermined time while a first indicator 190a is sensed in an inactive region 210 of an image 200 displayed on the detection surface 120 (S710).

In this case, the control unit 160 may receive the sensing information from the indicator detectors 130. The above-mentioned inactive region 210 is a region where the image 200 is not converted even though the indicators 190a and 190b are sensed in the region. And the above-mentioned inactive region 210 may be, for example, a part where the image configuration is not changed at the time of clicking one portion in a web browser.

Unlike this, an active region 220 is a region where the image 200 is converted when the indicators 190a and 190b are sensed.

If the second indicator 190b is sensed for a predetermined time, the control unit 160 may determine whether or not the second indicator 190b moves (S720). When the second indicator 190b moves, the control unit 160 may generate coordinates and operation information of the indicators 190a and 190b and transmit them to the image processing unit 170. The image processing unit 170 generates an image conversion signal for moving the image 200 on a movement route of the second indicator 190b and transmits the generated image conversion signal to the projection device 180 to move the image 200 (S730).

Meanwhile, at step S710, when the indicator 190b is not sensed for a predetermined time, the control unit 160 may determine whether the second indicator 190b is sensed twice (S740).

When the second indicator 190b is sensed once, the control unit 160 transmits the above-mentioned operation information and the like of the indicators 190a and 190b to the image processing unit 170 and the image processing unit 170 may generate an image conversion signal for arranging and displaying all tasks which are in progress in the image 200 on zoom-out windows 250 and transmit the generated image conversion signal to the projection device 180.

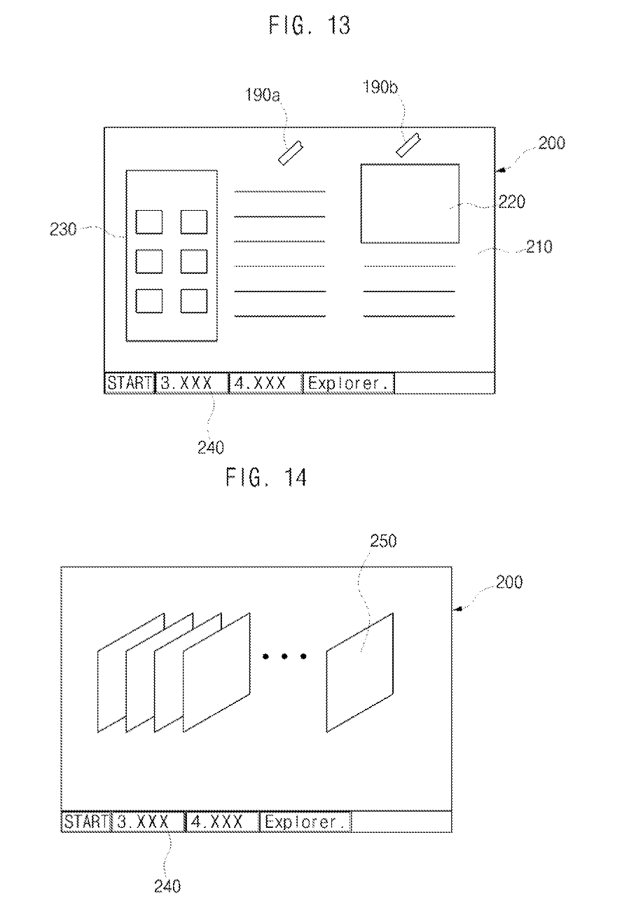

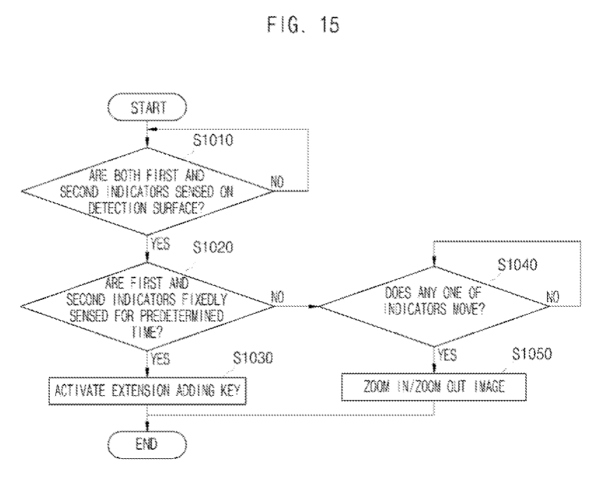

As a result, as shown in FIG. 14, all the tasks 240 in the image 200 may be arranged and displayed on the zoom-out windows 250 (S750). A user may move to the zoom-out window 250 where the user wants to work by using the indicator 190a.

Unlike this, when the detection of the second indicator 190b is performed twice, the control unit 160 may determine whether or not the second indicator 190b exists in an image of an extension adding key 230 (S760). The extension adding key 230 shown in FIG. 13 may provide convenient function keys when the user performs a write-in function in the image 200.

When the extension adding key 230 is present, the image processing unit 170 generates an image conversion signal for deactivating the extension adding key 230 to delete or deactivate the extension adding key 230 in the image 200 (S770).

In another exemplary embodiment, the change of the image configuration depending on the operation pattern of the second indicator has been described while the first indicator is firstly sensed and thereafter, is continuously sensed.

Hereinafter, referring to FIGS. 3, 13, and 15, in respects to the simultaneous sensing of the first and second indicators, an image display apparatus where both the first and second indicators are sensed and thereafter, the configuration of the image depending on an operation pattern of any one between the first and second indicators is changed will be described. FIG. 15 is a flowchart illustrating an operation relating to a change of a configuration of an image depending on an operation pattern of one indicator after both first and second indicators are sensed in an image display apparatus according to yet another exemplary embodiment of the present invention.

Referring to FIGS. 3, 13, and 15, first, the control unit 160 may determine whether both the first and second indicators 190a and 190b are sensed on the detection surface 120 (S1010).

Next, the control unit 160 may determine whether the first and second indicators 190a and 190b are continuously sensed for a predetermined time (S1020). If the first and second indicators 190a and 190b are continuously sensed, the control unit 160 transmits the operation information of the indicators 190a and 190b to the image processing unit 170 and the extension adding key 230 of the image 200 may be activated by the image processing unit 170 (S1030).

Unlike this, when the control unit 160 determines that the first and second indicators 190a and 190b are not continuously sensed at step S1020, the control unit 160 may determine again whether any one of the first and second indicators 190a and 190b moves (S1040).

When any one indicator 190 moves, the control unit 160 may transmit the operation information of the indicators 190a or 190b to the image processing unit 170 and a specific region of the image 200 is zoomed in or the entire image 200 may be zoomed out by the image processing unit 170 (S1050).

According to the exemplary embodiments of the present invention, the accuracy of image information photographed from an image sensor is improved by arranging a main sensing direction of the image sensor to be parallel to a detection surface so as to improve the sensing accuracy of an indicator.

Further, light sources in an indicator detector have different light sources by considering an incident distance and an incident angle, such that the illumination of reflected light has a uniform value.

Moreover, the reflected light may have uniform illumination by changing the shape of a reflection frame which is farther from the indicator detectors. As a result, the sensing accuracy of the indicator can be improved by sensing information generated based on the reflected light. Meanwhile, by converting a configuration of the image through various controls of the indicators in the image projected in the detection surface, it is possible to increase user's convenience on a touch screen having a large area.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image display apparatus, comprising:
an indicator detector disposed in the vicinity of a detection surface displaying an image and sensing an operation of an indicator on the detection surface and including an image sensor capable of controlling an angle between the detection surface and a main sensing direction; and
a reflection frame positioned in the vicinity of the detection surface.

2. The apparatus of claim 1, wherein the image sensor comprises a body tube positioned to face the reflection frame and a case disposed in the rear of the body tube and housing a sensor module,
the indicator detector comprises,
a mounting portion having space receiving the lower part of the image sensor;
a body tube supporter coupled with the mounting portion and partially supporting the lower part of the body tube;
a projection covering the top of the case in the vicinity of the body tube; and
a control member penetrating the projection and controlling the angle between the detection surface and the main sensing direction by vertically adjusting the case on the basis of the lower part of the body tube.

3. The apparatus of claim 2, wherein the indicator detector comprises a boby tube guide in the front of the body tube supporter.

4. An image display apparatus, comprising:
one or more indicator detectors disposed at the end of one side in the vicinity of a detection surface displaying an image and sensing an operation of an indicator on the detection surface; and
reflection frames disposed on sides other than the one side in the vicinity of the detection surface,
the reflection frame facing the one side comprises one or more protruded auxiliary reflectors.

5. The apparatus of claim 4, wherein the auxiliary reflector includes one or more inclined surfaces or rounded surfaces.

6. The apparatus of claim 4, wherein the plurality of auxiliary reflectors are disposed and when each of the auxiliary reflectors includes one inclined surface, inclined surfaces of the auxiliary reflectors are symmetrical to each other while facing each other on the basis of the centers of the reflection frames facing each other, and the auxiliary reflectors are disposed adjacent to each other on both ends of the reflection frame facing each other.

7. The apparatus of claim 4, wherein when the plurality of auxiliary reflectors are disposed, each of the auxiliary reflectors comprises two inclined surfaces and an angle between the both inclined surfaces is in the range of 40 to 180 degrees.

8. The apparatus of claim 4, wherein the auxiliary reflector has a size smaller than the indicator.

9. The apparatus of claim 4, wherein the reflection frame comprises a lower reflection frame facing the one side, and a left reflection frame and a right reflection frame positioned at the left side and the right side of the lower reflection frame, and the left and right reflection frames adjacent to the lower reflection frame comprises the auxiliary reflector.

10. An image display apparatus, comprising:
an indicator detector disposed in the vicinity of a detection surface displaying an image and sensing an operation of an indicator on the detection surface and comprising an image sensor and first and second light emitting elements positioned in the vicinity of the image sensor and having different illuminations; and
a reflection frame positioned in the vicinity of the detection surface.

11. The apparatus of claim 10, wherein when the first light emitting element has a larger incident distance than the second light emitting element, the first light emitting element has higher illumination than the second light emitting element.

12. An image display apparatus, comprising:
an indicator detector disposed in the vicinity of a detection surface displaying an image and sensing operations of first and second indicators on the detection surface;
a control unit calculating coordinates of the indicators in the detection surface on the basis of sensing information transmitted from the indicator detector and generating operation information relating to sequential sensing or simultaneous sensing of the first and second indicators;
an image processing unit generating an image conversion signal on the basis of the coordinates and the operation information transmitted from the control unit; and
a projection device projecting a converted image based on the image conversion signal transmitted from the image processing unit.

13. The apparatus of claim 12, wherein when the second indicator is continuously sensed and moves for a predetermined time while the first indicator is sensed on an inactive region of the detection surface, the image processing unit generates an image conversion signal for moving the image depending on a movement route of the second indicator.

14. The apparatus of claim 12, wherein when the second indicator is sensed for a time shorter than the predetermined time while the first indicator is sensed on the inactive region of the detection surface, the image processing unit arranges and displays all tasks in the image on zoom-out windows.

15. The apparatus of claim 12, wherein when the first and second indicators are sensed for the predetermined time while both the first and second indicators are fixed, the image processing unit generates an image conversion signal for activating an extension adding key in the image.

16. The apparatus of claim 15, wherein after the extension adding key is activated, when the second indicator is sensed twice while the first indicator is sensed in the inactive region of the detection surface, the image processing unit generates an image conversion signal for deactivating the extension adding key.

17. The apparatus of claim 12, wherein when the movement of any one indicator is sensed while both the first and second indicators are sensed for the predetermined time, the image processing unit generates an image conversion signal for zooming-in or zooming out the image with the movement of the indicator.
